(19) United States
(12) Patent Application Publication
(10) Pub. No.: US 2026/0085653 A1
(43) Pub. Date: Mar. 26, 2026

(54) DIGITALIZED AND INTELLIGENT SHAFT AXIS PROCESSING METHOD AND DEVICE FOR HYDRAULIC TURBINE GENERATOR UNIT

(71) Applicants: CSG POWER GENERATION CO., LTD. MAINTENANCE AND TEST COMPANY, Guangzhou (CN); GUANGZHOU QIMING SHUZHI ENERGY TECHNOLOGY CO., LTD., Guangzhou (CN)

(72) Inventors: Huazhe SHEN, Guangzhou (CN); Mengqi YANG, Guangzhou (CN); Jia CHEN, Guangzhou (CN); Xiao LIANG, Guangzhou (CN); Qing LI, Guangzhou (CN); Haijun JIA, Guangzhou (CN); Zhinan WANG, Guangzhou (CN); Huihui ZHENG, Guangzhou (CN); Yiyuan LU, Guangzhou (CN); Xiaoliang LI, Guangzhou (CN); Xiangwei HUANG, Guangzhou (CN); Sijie WANG, Guangzhou (CN)

(73) Assignees: CSG POWER GENERATION CO., LTD. MAINTENANCE AND TEST COMPANY, Guangzhou (CN); GUANGZHOU QIMING SHUZHI ENERGY TECHNOLOGY CO., LTD., Guangzhou (CN)

(21) Appl. No.: 19/405,517

(22) Filed: Dec. 2, 2025

Related U.S. Application Data
(63) Continuation of application No. PCT/CN2024/134918, filed on Nov. 27, 2024.

(30) Foreign Application Priority Data
Mar. 25, 2024 (CN) 202410339270.9

(51) Int. Cl. F03B 13/00; H02P 9/10; H02P 101/10

(52) U.S. Cl. CPC F03B 13/00; H02P 9/105; F05D 2220/76; H02P 2101/10

(57) ABSTRACT

The present application relates to a digitalized and intelligent shaft axis processing method and device for a hydraulic turbine generator unit, and a computer device, a storage medium and a computer program product. The method comprises: receiving runout data collected by a dial indicator disposed on a designated part of the hydraulic turbine generator unit; generating net runout curves of the designated part based on the runout data, calculating net total runout data of the designated part based on the net runout curves, and generating a shaft axis data diagram of the hydraulic turbine generator unit, and performing a shaft axis processing prediction for the hydraulic turbine generator unit based on the net total runout data and the shaft axis data diagram to obtain a shaft axis processing scheme for the hydraulic turbine generator unit.

### CROSS-REFERENCE TO RELATED APPLICATIONS

This application is a continuation application of International Application PCT/CN2024/134918, filed on Nov. 27, 2024, which claims priority to Chinese Patent Application No. 2024103392709, filed on Mar. 25, 2024, entitled “DIGITALIZED AND INTELLIGENT SHAFT AXIS PROCESSING METHOD AND DEVICE FOR HYDRAULIC TURBINE GENERATOR UNIT”, which are hereby incorporated by reference in their entireties.

### TECHNICAL FIELD

This application relates to a digitalized and intelligent shaft axis processing method and device for a hydraulic turbine generator unit, a computer device, a non-transitory computer-readable storage medium, and a computer program product.

### BACKGROUND

With the development of the power engineering field, hydraulic turbine generator units have important applications in many fields. Through maintaining a shaft axis of a hydraulic turbine generator unit, the operating efficiency and stability of the hydraulic turbine generator unit may be assessed, which is crucial for ensuring reliable power supply and improving power generation efficiency. Therefore, how to efficiently determine the shaft axis processing scheme for a hydraulic turbine generator unit has become an important research direction.

### SUMMARY

According to various embodiments of this application, a digitalized and intelligent shaft axis processing method and device for a hydraulic turbine generator unit, a computer device, a non-transitory computer-readable storage medium, and a computer program product are provided.

A digitalized and intelligent shaft axis processing method for a hydraulic turbine generator unit is disclosed. The hydraulic turbine generator unit includes a dial indicator disposed on a designated part and a terminal, the dial indicator is connected to the terminal via a data cable, and the shaft axis processing method for the hydraulic turbine generator unit includes following steps. The dial indicator collects first runout data of the designated part in a first preset direction (X) at multiple shaft angle positions and second runout data of the designated part in a second preset direction (Y) at the multiple shaft angle positions during a rotation of the hydraulic turbine generator unit. The terminal receives the first runout data of the designated part of the hydraulic turbine generator unit in the first preset direction (X) at the multiple shaft angle positions and the second runout data of the designated part in the second preset direction (Y) at the multiple shaft angle positions sent by the dial indicator. The terminal generates a first net runout curve in the first preset direction based on the first runout data, and generates a second net runout curve in the second preset direction based on the second runout data. The terminal performs a matching detection on the first net runout curve and the second net runout curve to determine whether the first net runout curve and the second net runout curve match with each other. Corresponding to a determination that the first net runout curve and the second net runout curve match with each other, the terminal uses the first net runout curve and the second net runout curve as the net runout curves of the designated part, and corresponding to a determination that the first net runout curve and the second net runout curve do not match with each other, the terminal checks whether collected data is incorrect or instructs the dial indicator to repeat measurement to generate new net runout curves for the matching detection. The terminal calculates net total runout data of the designated part based on the net runout curves of the designated part, and generates a shaft axis data diagram of the hydraulic turbine generator unit based on the net total runout data. The terminal performs a shaft axis processing prediction for the hydraulic turbine generator unit based on the net total runout data and the shaft axis data diagram to obtain a shaft axis processing scheme for the hydraulic turbine generator unit. A display unit of the terminal outputs the shaft axis processing scheme to guide an adjustment of the hydraulic turbine generator unit on site to correct the shaft axis of the hydraulic turbine generator unit to a qualified operating state.

In an embodiment, dial indicators are disposed in the first preset direction (X) and the second preset direction (Y) of the designated part, respectively. The designated part comprises at least one of a lower guide bearing, an intermediate shaft upper flange, an intermediate shaft lower flange, or a water guide bearing.

In an embodiment, the shaft axis processing method for the hydraulic turbine generator unit further includes corresponding to the determination that the first net runout curve and the second net runout curve do not match with each other, the terminal generating an alarm signal.

In an embodiment, the terminal performing the shaft axis processing prediction for the hydraulic turbine generator unit based on the net total runout data and the shaft axis data diagram to obtain the shaft axis processing scheme for the hydraulic turbine generator unit, includes following steps. The terminal obtains a diameter of a thrust collar clamping ring of the hydraulic turbine generator unit and a distance between each designated part and a restraint guide bearing of the hydraulic turbine generator unit, and uses the diameter and the distances as equipment parameters of the hydraulic turbine generator unit. The terminal performs the shaft axis processing prediction for the hydraulic turbine generator unit based on the equipment parameters, the net total runout data, and the shaft axis data diagram to obtain the shaft axis processing scheme for the hydraulic turbine generator unit.

In an embodiment, the terminal obtaining the diameter of the thrust collar clamping ring of the hydraulic turbine generator unit and the distance between each designated part and the restraint guide bearing of the hydraulic turbine generator unit, includes an input device of the terminal receiving the diameter of the thrust collar clamping ring of the hydraulic turbine generator unit and the distance between each designated part and the restraint guide bearing of the hydraulic turbine generator unit.

In an embodiment, the terminal performing the shaft axis processing prediction for the hydraulic turbine generator unit based on the equipment parameters, the net total runout data, and the shaft axis data diagram to obtain the shaft axis processing scheme for the hydraulic turbine generator unit, includes following steps. The terminal performs the shaft axis processing prediction for the hydraulic turbine generator unit based on the equipment parameters, the net total runout data, and the shaft axis data diagram to obtain a shaft axis processing scheme for the designated part and a comprehensive shaft axis processing scheme for the hydraulic turbine generator unit. The terminal generates a scraping scheme for thrust collar clamping ring and a diagram of scraping amount for each zone of the thrust collar clamping ring of the hydraulic turbine generator unit based on the shaft axis processing scheme for the designated part and the comprehensive shaft axis processing scheme for the hydraulic turbine generator unit. The terminal uses the scraping scheme for the thrust collar clamping ring and the diagram of the scraping amount for each zone of the thrust collar clamping ring as the shaft axis processing scheme for the hydraulic turbine generator unit.

In an embodiment, after the terminal using the scraping scheme for the thrust collar clamping ring and the diagram of the scraping amount for each zone of the thrust collar clamping ring as the shaft axis processing scheme for the hydraulic turbine generator unit, the method further includes the terminal generating a comparison diagram of shaft axis states of the hydraulic turbine generator unit before and after the thrust collar clamping ring is scraped based on the scraping scheme for the thrust collar clamping ring and the diagram of the scraping amount for each zone of the thrust collar clamping ring, and the terminal using the shaft axis processing scheme and the comparison diagram of the shaft axis states as auxiliary information for scraping the thrust collar clamping ring of the hydraulic turbine generator unit.

In an embodiment, each zone of the thrust collar clamping ring is a circumferential zone, and the diagram of the scraping amount for each zone of the thrust collar clamping ring indicates a thickness of material to be mechanically removed from the clamping ring in different circumferential zones.

In an embodiment, the terminal calculating the net total runout data of the designated part based on the net runout curves of the designated part, and generating the shaft axis data diagram of the hydraulic turbine generator unit based on the net total runout data, includes: calculating the net total runout data of the designated part based on the net runout curves, and generating a shaft axis state diagram and a shaft runout polar plot of the hydraulic turbine generator unit before the shaft axis is processed based on the net total runout data of the designated part; and using both the shaft axis state diagram and the shaft runout polar plot as the shaft axis data diagrams.

This application also provides a digitalized and intelligent shaft axis processing device for a hydraulic turbine generator unit, the hydraulic turbine generator unit includes a dial indicator disposed in a designated part, the dial indicator is connected to the digitalized and intelligent shaft axis processing device for the hydraulic turbine generator unit via a data cable.

The dial indicator is configured to collect first runout data of the designated part in a first preset direction (X) at multiple shaft angle positions and second runout data of the designated part in a second preset direction (Y) at the multiple shaft angle positions during a rotation of the hydraulic turbine generator unit.

The digitalized and intelligent shaft axis processing device for the hydraulic turbine generator unit includes: a data acquisition circuit, a curve generation circuit, a data calculation circuit, a unit prediction circuit, and a display unit.

The data acquisition circuit, whose input terminal is connected to an output terminal of the dial indicator, is configured to receive the first runout data of the designated part of the hydraulic turbine generator unit in the first preset direction (X) at the multiple shaft angle positions and the second runout data of the designated part in the second preset direction (Y) at the multiple shaft angle positions sent by the dial indicator.

The curve generation circuit, whose input terminal is connected to the output terminal of the data acquisition circuit, is configured to generate a first net runout curve of the first preset direction based on the first runout data, and generate a second net runout curve of the second preset direction based on the second runout data; perform a matching detection on the first net runout curve and the second net runout curve to determine whether the first net runout curve and the second net runout curve match with each other; corresponding to a determination that the first net runout curve and the second net runout curve match with each other, use the first net runout curve and the second net runout curve as the net runout curves of the designated part, and corresponding to a determination that the first net runout curve and the second net runout curve do not match, check whether collected data is incorrect or instruct the dial indicator to repeat measurement to generate new net runout curves for the matching detection.

The data calculation circuit, whose input terminal is connected to the output terminal of the curve generation circuit, is configured to calculate net total runout data of the designated part based on the net runout curves of the designated part, and generate a shaft axis data diagram of the hydraulic turbine generator unit based on the net total runout data.

The unit prediction circuit, whose input terminal is connected to the output terminal of the data calculation circuit, is configured to perform a shaft axis processing prediction for the hydraulic turbine generator unit based on the net total runout data and the shaft axis data diagram to obtain a shaft axis processing scheme for the hydraulic turbine generator unit.

The display unit, whose input terminal is connected to the output terminal of the unit prediction circuit, is configured to output the shaft axis processing scheme to guide an adjustment of the hydraulic turbine generator unit on site to correct the shaft axis of the hydraulic turbine generator unit to a qualified operating state.

A computer device is a terminal including a memory and one or more processors, and the memory stores computer-readable instructions. The computer-readable instructions, when executed by the processors, perform the digitalized and intelligent shaft axis processing method for the hydraulic turbine generator unit provided in any one of the embodiments of this application.

A non-transitory computer-readable storage medium, having computer-readable instructions stored thereon. The computer is a terminal, and the computer-readable instructions, when executed by one or more processors of the terminal, cause the one or more processors to perform the digitalized and intelligent shaft axis processing method for the hydraulic turbine generator unit provided in any one of the embodiments of this application.

A computer program product includes computer-readable instructions, the computer is a terminal, and the computer-readable instructions, when executed by the processor of the terminal, perform the digitalized and intelligent shaft axis processing method for the hydraulic turbine generator unit provided in any one of the embodiments of this application.

Details of one or more embodiments of this application are set forth in the following drawings and description. Other features, objectives, and advantages of this application will become apparent from the specification, drawings, and claims.

### BRIEF DESCRIPTION OF THE DRAWINGS

To more clearly illustrate the technical solutions in the embodiments of this application or in the conventional technology, the drawings used in the description of the embodiments or the conventional technology will be briefly described below. Obviously, the drawings described below are only embodiments of this application. For those ordinary skilled in the art, other drawings may be obtained based on the disclosed drawings without creative efforts.

FIG. 1 is a schematic flowchart illustrating a digitalized and intelligent shaft axis processing method for a hydraulic turbine generator unit according to one or more embodiments.

FIG. 2 is a schematic diagram showing first net runout curves according to one or more embodiments.

FIG. 3 is a schematic diagram showing second net runout curves according to one or more embodiments.

FIG. 4 is a schematic diagram showing a shaft axis state before scraping a thrust collar clamping ring according to one or more embodiments.

FIG. 5 shows a shaft runout polar plot before scraping the thrust collar clamping ring according to one or more embodiments.

FIG. 6 is a schematic diagram shows scraping amount for each zone of the thrust collar clamping ring according to one or more embodiments.

FIG. 7 shows a comparison diagram of the shaft axis states of the hydraulic turbine generator unit before and after scraping the thrust collar clamping ring according to one or more embodiments.

FIG. 8 a block diagram showing a digitalized and intelligent shaft axis processing device for a hydraulic turbine generator unit according to one or more embodiments.

FIG. 9 is a block diagram showing a computer device according to one or more embodiments.

### DETAILED DESCRIPTION OF THE EMBODIMENTS

The technical solutions in the embodiments of this application will be clearly and completely described below with reference to the accompanying drawings. Obviously, the described embodiments are only some embodiments of this application, but are not all embodiments. Based on the embodiments of this application, all other embodiments obtained by those ordinary skilled in the art without creative efforts are within the scope of protection of this application.

In the related art, a shaft axis processing scheme for a hydraulic turbine generator unit is determined through manual measurement and adjustment. However, a manual development of determining a shaft axis processing scheme for the hydroelectric generator unit in this manner will be more time-consuming, thus resulting in a low efficiency of determining the shaft axis processing scheme for the hydraulic turbine generator unit.

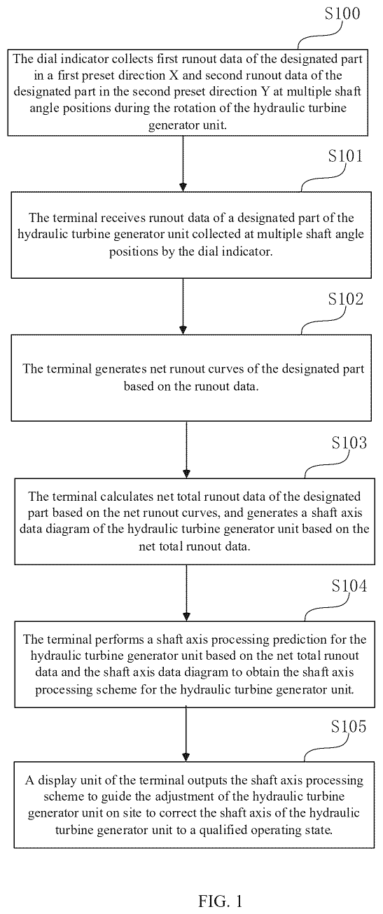

In an embodiment, as shown in FIG. 1, a digitalized and intelligent shaft axis processing method for a hydraulic turbine generator unit is provided. The embodiment is described by taking the method executed via a terminal connected to a dial indicator disposed on a designated part of the hydraulic turbine generator unit as an example. It should be understood that the method may also be executed by a server connected to the dial indicator installed on the designated part of the hydraulic turbine generator unit, or may also be executed by a system including a terminal and a server, which are connected to the dial indicator installed on the designated part of the hydraulic turbine generator unit, and is implemented through an interaction between the terminal and the server. The terminal may be, but is not limited to, various personal computers, laptops, smartphones, tablets, etc. The server may be an independent dedicated server or a server cluster consisting of multiple servers. In the embodiments of this application, the shaft axis processing method for the hydraulic turbine generator unit is applied to the hydraulic turbine generator unit. The hydraulic turbine generator unit includes a dial indicator disposed on the designated part and a terminal, and the dial indicator is connected to the terminal via a data cable. The shaft axis processing method for the hydraulic turbine generator unit includes the following steps S101 to S104.

In step S101, the terminal receives runout data of a designated part of the hydraulic turbine generator unit collected by the dial indicator at multiple shaft angle positions.

The hydraulic turbine generator unit may be the entire hydraulic turbine generator unit, and may include a turbine and a generator.

The dial indicator may be a precision measuring instrument used for remote data acquisition, such as a percentage micrometer.

Runout data may be raw data of the designated part of the hydraulic turbine generator unit collected by the dial indicator at multiple shaft angle positions. A shaft angle position, i.e., a measuring point, refers to a circumferential angular position of the designated part of the hydraulic turbine generator unit during its rotation. A shaft angle number may be a measuring point number of the designated part, such as shaft angle position 1, shaft angle position 3, etc.

The designated part may be a main component of the hydraulic turbine generator unit that needs to be diagnosed, such as an upper guide bearing journal or a lower guide bearing journal, or at least one of an upper guide bearing, a lower guide bearing, an intermediate shaft upper flange, an intermediate shaft lower flange, or a water guide bearing.

In an embodiment, the dial indicator is pre-installed on the designated part of the hydraulic turbine generator unit for data collection. The hydraulic turbine generator unit is rotated by barring or other manners, and the dial indicator collects raw runout data of various designated parts and at various shaft angle positions. Then the dial indicator transmits the collected raw runout data to the terminal, and the terminal obtains the runout data of the designated parts of the hydraulic turbine generator unit collected by the dial indicator.

In an embodiment of this application, prior to step S101, the shaft axis processing method for the hydraulic turbine generator unit further includes step S100, and in step S100, a dial indicator collects the runout data of the designated part at multiple shaft angle positions. Specifically, the dial indicator collects first runout data of the designated part in a first preset direction X at multiple shaft angle positions and second runout data of the designated part in the second preset direction Y at multiple shaft angle positions during the rotation of the hydraulic turbine generator unit. The first preset direction X and the second preset direction Y are two mutually perpendicular directions within a plane perpendicular to the main shaft of the hydroelectric generator unit. The multiple shaft angle positions refer to various circumferential angle positions of the designated part of the hydraulic turbine generator unit during the rotation of the designated part of the hydraulic turbine generator unit.

In step S102, the terminal generates net runout curves of the designated part based on the runout data.

The net runout curves may include a first net runout curve and a second net runout curve, which are plotted based on the swing degree of the designated part between two adjacent shaft angle positions along the first preset direction X and the second preset direction Y, respectively. The first preset direction X may represent a horizontal axis positive direction and the second preset direction Y may represent a vertical axis positive direction.

In an embodiment, the terminal generates the net runout curves of different preset directions for each designated part of the hydraulic turbine generator unit, based on the runout data of each designated part of the hydraulic turbine generator unit collected by the dial indicator at multiple shaft angle positions.

In step S103, the terminal calculates net total runout data of the designated part based on the net runout curves, and generates a shaft axis data diagram of the hydraulic turbine generator unit based on the net total runout data.

The net total runout data refers to a total swing degree of the designated part in the first preset direction and the second preset direction, relative to the rotational center (i.e., the upper guide bearing) of the hydraulic turbine generator unit, at each shaft angle position. This total swing degree is a vector defined by its components: the first runout data and the second runout data of the designated part.

The shaft axis data diagram may be a schematic diagram of the state of the shaft axis of the hydraulic turbine generator unit.

In an embodiment, the terminal calculates the net total runout data of each designated part at each shaft angle position based on the net runout curves, and draws the shaft axis data diagram of the hydraulic turbine generator unit based on the net total runout data of the designated part at all shaft angle positions.

In step S104, the terminal performs a shaft axis processing prediction for the hydraulic turbine generator unit based on the net total runout data and the shaft axis data diagram to obtain the shaft axis processing scheme for the hydraulic turbine generator unit.

The shaft axis processing prediction may be a predicted shaft axis processing scheme that satisfies the runout requirements of each designated part.

The shaft axis processing scheme may provide specific processing schemes, such as the scraping amount for the thrust collar clamping ring and zones thereof, in order to adjust the shaft axis of the hydraulic turbine generator unit to meet the requirements.

In an embodiment, the terminal analysis the shaft axis processing prediction for the hydraulic turbine generator unit based on the net total runout data and the shaft axis data diagram to obtain the shaft axis processing scheme for the hydraulic turbine generator unit that meets the requirements. Based on the shaft axis processing scheme, corresponding shaft axis adjustment is performed on site, such as scraping the thrust collar clamping ring, to complete the shaft axis diagnosis process. After the processing is completed, the above procedures may be performed repeatedly to detect the shaft axis until the shaft axis meets the preset qualified standard.

In the above embodiments of this application, the shaft axis processing method for the hydraulic turbine generator unit further includes step S105, and in the step S105, a display unit of the terminal outputs the shaft axis processing scheme to guide the adjustment of the hydraulic turbine generator unit on site to correct the shaft axis of the hydraulic turbine generator unit to a qualified operating state.

In the aforementioned digitalized and intelligent shaft axis processing method for the hydraulic turbine generator unit, the dial indicator collects the first runout data of the designated part in the first preset direction X at multiple shaft angle positions and the second runout data of the designated part in the second preset direction Y at multiple shaft angle positions during the rotation of the hydraulic turbine generator unit. The terminal receives the runout data of the designated part of the hydraulic turbine generator unit collected by the dial indicator at multiple shaft angle positions, generates net runout curves of the designated part based on the runout data, calculates net total runout data of the designated part based on the net runout curves, and generates the shaft axis data diagram of the hydraulic turbine generator unit based on the net total runout data, and performs the shaft axis processing prediction for the hydraulic turbine generator unit based on the net total runout data and the shaft axis data diagram to obtain the shaft axis processing scheme for the hydraulic turbine generator unit. Finally, the display unit of the terminal outputs the shaft axis processing scheme to guide the adjustment of the hydraulic turbine generator unit on site to correct the shaft axis of the hydraulic turbine generator unit to the qualified operating state. In this embodiment, the dial indicator collects the runout data of the designated part at multiple shaft angle positions during the rotation of the hydraulic turbine generator unit. The terminal generates the net runout curves of the designated part based on the runout data of the designated part collected by the dial indicator at multiple shaft angle positions, calculates the net total runout data of the designated part based on the net runout curves, and generates the shaft axis data diagram of the hydraulic turbine generator unit based on the net total runout data of the designated part, and performs the shaft axis processing prediction for the hydraulic turbine generator unit based on the net total runout data and the shaft axis data diagram to obtain the shaft axis processing scheme for the hydraulic turbine generator unit. The display unit of the terminal outputs the shaft axis processing scheme to guide the adjustment of the hydraulic turbine generator unit on site to correct the shaft axis of the hydraulic turbine generator unit to the qualified operating state. Thus, in the process of performing the digital and intelligent shaft axis processing for the hydraulic turbine generator unit, the entire process of online shaft axis diagnosis and processing is digitized and intelligent, thereby facilitating improving the efficiency and accuracy of the shaft axis processing for the hydraulic turbine generator unit.

In an embodiment, the step S101 of the terminal receiving runout data of the designated part of the hydraulic turbine generator unit collected by the dial indicator at multiple shaft angle positions, specifically includes: the terminal receiving the first runout data of the first preset direction X and the second runout data of the second preset direction Y sent by the dial indicators. Both the first runout data and the second runout data are collected by the dial indicators while the hydroelectric turbine generator unit is in a barring state, i.e., during the rotation of the hydraulic turbine generator unit. Both the first runout data and the second runout data are considered as runout data.

Dial indicators are installed in the first preset direction X and the second preset direction Y of the designated part respectively.

The first preset direction may be the direction in which a first dial indicator disposed on the designated part collects data, such as the positive X direction (i.e., the positive direction of the horizontal axis).

The second preset direction may be the direction in which a second dial indicator disposed on the designated part collects data, such as the positive Y direction (the positive direction of the vertical axis).

The first runout data may be the raw runout data collected by the first dial indicator in the first preset direction X.

The second runout data may be the raw runout data collected by the second dial indicator in the second preset direction Y.

The barring state may be the state in which the hydraulic turbine generator unit is rotated manually or mechanically for shaft axis diagnosis.

The runout data may include the first runout data and the second runout data collected simultaneously by two dial indicators in different directions, which may be used as the overall input data for subsequent calculations and processing.

In an embodiment, two dial indicators are installed on each designated part (i.e., a characteristic part) of the hydraulic turbine generator unit in the first preset direction X and the second preset direction Y, respectively. These dial indicators are connected to the terminal via the data cables. Start barring the hydraulic turbine generator unit to rotate it. During the rotation of the hydraulic turbine generator unit, the dial indicators collect the raw runout data of the designated part at different shaft angle positions in the first preset direction X and the second preset direction Y, respectively. The dial indicators transmit the collected data to the terminal in real time via data cables in the form of electrical signals. The terminal receives the first runout data sent by the dial indicator arranged in the first preset direction X and the second runout data sent by the dial indicator arranged in the second preset direction Y. The first runout data and the second runout data collected in these two directions respectively are used as the runout data of the designated part. The above process is repeated to obtain data of another designated part in both directions, until data collection is completed for all designated parts.

In the technical solutions of this embodiment, different dial indicators simultaneously collect the runout data in different directions, respectively, which facilitates obtaining more diverse and accurate runout data to improve the accuracy of shaft axis diagnosis, thereby enhancing the accuracy of the shaft axis processing for the hydraulic turbine generator unit.

In an embodiment, step S102 of the terminal generating the net runout curves of the designated part based on the runout data, specifically includes: generating the first net runout curve of the first preset direction based on the first runout data; generating the second net runout curve of the second preset direction based on the second runout data; performing a matching detection on the first net runout curve and the second net runout curve to determine whether the first net runout curve and the second net runout curve match with each other; corresponding to a determination that the first net runout curve and the second net runout curve match with each other, using both the first net runout curve and the second net runout curve as the net runout curves of the designated part; corresponding to a determination that the first net runout curve and the second net runout curve do not match with each other, checking whether the collected data is incorrect or instructing the dial indicators to repeat the measurement to generate new net runout curves for matching detection.

The first net runout curve may be obtained through calculation based on the first runout data collected by the dial indicator in the first preset direction X. In an embodiment of this application, the first net runout curve is a curve drawn based on the swing degree of the designated part between two adjacent shaft angle positions in the first preset direction X. Specifically, in an embodiment of the application, the center of the upper guide bearing is used as the rotation center of the hydraulic turbine generator unit, and the dial indicators disposed in the first direction X respectively collect runout data of the designated part and the upper guide bearing at multiple equally spaced points (i.e., multiple shaft angle positions or multiple measuring points) during one complete revolution of the hydraulic turbine generator unit. The runout data of designated part at each measuring point is subtracted from the runout data of the upper guide bearing at the corresponding measuring point, finally obtaining the net runout value of the designated part at each of the shaft angle position (i.e., each measuring point). Based on the net runout values at the measuring points, the first net runout curve of the designated part is drawn. For example, the first net runout curve of the lower guide bearing is obtained, i.e., the net runout curve of the lower guide bearing in the first direction X is obtained.

The second net runout curve may be calculated based on the net runout data collected by the dial indicator in the second preset direction Y. In an embodiment of this application, the second net runout curve is a curve drawn based on the swing degree of the designated part between two adjacent shaft angle positions in the second preset direction Y. Specifically, in an embodiment of the application, the center of the upper guide bearing is used as the rotation center of the hydraulic turbine generator unit, and the dial indicators disposed in the second direction Y respectively collect runout data of the designated part and the upper guide bearing at multiple equally spaced points (i.e., multiple shaft angle positions or multiple measuring points) during one complete revolution of the hydraulic turbine generator unit. The runout data of designated part at each measuring point is subtracted from the runout data of the upper guide bearing at the corresponding measuring point, finally obtaining the net runout value of the designated part at each of the shaft angle position (i.e., each measuring point). Based on the net runout values at the measuring points, the second net runout curve of the designated part is drawn. For example, the second net runout curve of the lower guide bearing is obtained, i.e., the net runout curve of the lower guide bearing in the second direction Y is obtained.

Net runout curve detection involves carrying out a matching detection for the first net runout curve and the second net runout curve to determine whether they match with each other. In an embodiment of this application, determining whether the first and second net runout curves match with each other can be based on determining whether the ratio of the oscillation amplitude of the second net runout curve to the oscillation amplitude of the first net runout curve is within a threshold range, such as 0.8-1.2. For example, if the maximum oscillation amplitude of the first net runout curve is 0.10 mm and the maximum oscillation amplitude of the second net runout curve is 0.09 mm, the ratio is 0.9, it is determined that the first and second net runout curves match with each other. If the maximum oscillation amplitude of the first net runout curve is 0.10 mm and the maximum oscillation amplitude of the second net runout curve is 0.50 mm, the ratio is 5, it is determined that the first and second net runout curves do not match. In other embodiments of this application, determining whether the first and second net runout curves match with each other may alternatively involve determining whether the dynamic change trends of the first and second net runout curves reflect the same physical phenomenon, such as measurement errors.

In an embodiment, the terminal generates the first net runout curve corresponding to the first preset direction X based on the first runout data, and generates the second net runout curve corresponding to the second preset direction Y based on the second runout data, then carries out the matching detection on the first net runout curve and the second net runout curve to determine whether the two curves match with each other. Corresponding to the determination that the first net runout curve and the second net runout curve match with each other, the terminal directly uses the first net runout curve and the second net runout curve as the net runout curves of the designated part. Corresponding to the determination that the first net runout curve and the second net runout curve do not match with each other, it is necessary to check whether the measurement data is incorrect, or the terminal instructs the dial indicator to repeat the measurement to generate new net runout curves for matching detection.

In the technical solution of the embodiment, the data collected in two directions are used to cross-verify each other, thereby improving the reliability and the accuracy of the net runout curves, and facilitating improving the accuracy of the shaft axis processing for the hydraulic turbine generator unit.

In an embodiment, step S104 of performing a shaft axis processing prediction for the hydraulic turbine generator unit based on the net total runout data and the shaft axis data diagram, to obtain the shaft axis processing scheme for the hydraulic turbine generator unit, specifically includes: obtaining a diameter of the thrust collar clamping ring of the hydraulic turbine generator unit and a distance between each designated part and a restraint guide bearing of the hydraulic turbine generator unit, and using the diameter and the distances as equipment parameters of the hydraulic turbine generator unit; and performing the shaft axis processing prediction for the hydraulic turbine generator unit based on the equipment parameters, the net total runout data, and the shaft axis data diagram to obtain the shaft axis processing scheme for the hydraulic turbine generator unit.

The thrust collar clamping ring may be a clamping ring component installed on the turbine shaft for adjusting the shaft axis.

The thrust collar clamping ring diameter may be a dimension of a diameter of the thrust collar clamping ring.

The restraint guide bearing may be a bearing component that is relatively fixed to the main components (i.e., the designated parts) of the hydraulic turbine generator unit. In an embodiment of this application, the restraint guide bearing refers to the upper guide bearing.

The distance between each designated part and the restraint guide bearing may be the distance between each of the main components of the hydraulic turbine generator unit and the restraint guide bearing.

The equipment parameters may be the structural parameters of the hydraulic turbine generator unit.

In an embodiment, the terminal obtains the diameter of the thrust collar clamping ring of the hydraulic turbine generator unit and the distance between each designated part and the restraint guide bearing of the hydraulic turbine generator unit. The diameter of the thrust collar clamping ring and the distance between each designated part and the restraint guide bearing of the hydraulic turbine generator unit are used as the equipment parameters of the hydraulic turbine generator unit. Based on the equipment parameters, the net total runout data and the shaft axis data diagram, the shaft axis processing prediction is performed for the hydraulic turbine generator unit to obtain the shaft axis processing scheme for the hydraulic turbine generator unit.

In the technical solutions provided in the embodiment, the shaft axis processing scheme for the hydraulic turbine generator unit is determined based on the equipment parameters, the net total runout data, and the shaft axis data diagram, thereby facilitating improving the efficiency and accuracy of the shaft axis processing for the hydraulic turbine generator unit.

In an embodiment, performing the shaft axis processing prediction for the hydraulic turbine generator unit based on equipment parameters, the net total runout data, and the shaft axis data diagram to obtain the shaft axis processing scheme for the hydraulic turbine generator unit, specifically includes: performing the shaft axis processing prediction for the hydraulic turbine generator unit based on the equipment parameters, the net total runout data, and the shaft axis data diagram to obtain a shaft axis processing scheme for the designated part and a comprehensive shaft axis processing scheme for the hydraulic turbine generator unit; generating a scraping scheme for thrust collar clamping ring and a diagram of scraping amount for each zone of the thrust collar clamping ring of the hydraulic turbine generator unit based on the shaft axis processing scheme for the designated part and the comprehensive shaft axis processing scheme for the hydraulic turbine generator unit; and using the scraping scheme for the thrust collar clamping ring and the diagram of scraping amount for each zone of the thrust collar clamping ring as the shaft axis processing scheme.

The shaft axis processing scheme for the designated part may be the scraping scheme for the thrust collar clamping ring provided for a single designated part to meet the axis requirements of this single designated part.

The comprehensive shaft processing scheme for the hydraulic turbine generator unit may be the optimal scraping scheme for the thrust collar clamping ring, which takes into account the shaft axis requirements for all designated parts.

The scraping scheme for the thrust collar clamping ring may include specific scraping amount for the thrust collar clamping ring.

The diagram of scraping amount for each zone of the thrust collar clamping ring may be a graphical representation that shows the scraping amount for each zone of the thrust collar clamping ring which needs to be scraped by zones.

The shaft axis processing scheme may include the scraping scheme for the thrust collar clamping ring and the schematic diagram of scraping amount for each zone of the thrust collar clamping ring, and provides a reference for the shaft axis adjustment for the hydraulic turbine generator unit.

In an embodiment, the terminal carries out the shaft axis processing prediction calculation based on the equipment parameters of the hydraulic turbine generator unit (such as the diameter of the thrust collar clamping ring, the distance between parts, etc.), the net total runout data of each designated part, and the shaft axis data diagram, to obtain an individual shaft axis processing scheme for each designated part, i.e., the scraping scheme for the thrust collar clamping ring for this designated part. Simultaneously, by comprehensively considering the requirements of all designated parts, an overall shaft axis processing scheme for the hydraulic turbine generator unit is provided. Based on the individual shaft axis processing scheme for the designated part and the overall shaft axis processing scheme, the comprehensive scraping scheme for the thrust collar clamping ring of the hydraulic turbine generator unit is generated, that is, the specific scraping amounts required at different positions. Based on the scraping scheme for the thrust collar clamping ring, a schematic diagram of the scraping amount needed for each zone of the thrust collar clamping ring is generated, and used as a schematic diagram of the scraping amount for each zone of the thrust collar clamping ring of the hydraulic turbine generator unit. The scraping scheme for the thrust collar clamping ring and the schematic diagram of the scraping amount for each zone of the thrust collar clamping ring are used as the shaft axis processing scheme for the hydraulic turbine generator unit. Based on this shaft axis processing scheme, the actual thrust collar clamping ring scraping is performed, thus completing the shaft axis processing for the hydraulic turbine generator unit.

In the technical solutions provided in this embodiment, the shaft axis processing scheme for the hydraulic turbine generator unit is determined by using the scraping scheme for the thrust collar clamping ring and the schematic diagram of the scraping amount for each zone of the thrust collar clamping ring as the shaft axis processing scheme based on the processing scheme for each designated part and the comprehensive shaft axis processing scheme, thereby facilitating improving the accuracy of the shaft axis processing for the hydraulic turbine generator.

In an embodiment, after using the scraping scheme for the thrust collar clamping ring and the schematic diagram of the scraping amount for each zone of the thrust collar clamping ring as the shaft axis processing scheme, the following steps are also included: generating a comparison diagram of the shaft axis states of the hydraulic turbine generator unit before and after the thrust collar clamping ring is scraped based on the scraping scheme for the thrust collar clamping ring and the schematic diagram of the scraping amount for each zone of the thrust collar clamping ring; and using the shaft axis processing scheme and the comparison diagram of the shaft axis states as auxiliary information for scraping the thrust collar clamping ring of the hydraulic turbine generator unit.

The thrust collar clamping ring may be a component that connects the main shaft of the hydraulic turbine generator unit, and the shaft axis position may be adjusted by scraping the thrust collar clamping ring.

The comparison schematic diagram of the shaft axis states of the hydraulic turbine generator unit before and after the thrust collar clamping ring are scraped may be used to visually compare the shaft axis change of the hydraulic turbine generator unit.

The auxiliary information may be additional information provided to on-site operators for reference, in order to assist in the scraping of the thrust collar clamping ring.

In an embodiment, the terminal generates the comparison schematic diagram of the shaft axis states of the hydraulic turbine generator unit before and after the thrust collar clamping ring are scraped, based on the scraping scheme for the thrust collar clamping ring and the schematic diagram of the scraping amount for each zone of the thrust collar clamping ring. The shaft axis processing scheme and the comparison schematic diagram of the shaft axis states, as auxiliary information for scraping the thrust collar clamping ring of the hydraulic turbine generator unit, are provided to the on-site operators, serving as reference information for scraping the thrust collar clamping ring. In an embodiment, the schematic diagram of the scraping amount for each zone of the thrust collar clamping ring indicates the thickness of material to be mechanically removed from the clamping ring in different circumferential zones.

In the technical solutions in the embodiment, the comparison schematic diagram of the shaft axis states, along with the shaft axis processing scheme, is used as an auxiliary reference for scraping the thrust collar clamping ring, to adjust the shaft axis of the hydraulic turbine generator unit, thereby facilitating improving the accuracy of the shaft axis processing of the hydraulic turbine generator unit.

In an embodiment, the step S103 of calculating the net total runout data of the designated part based on the net runout curves, and generating the shaft axis data diagram of the hydraulic turbine generator unit based on the net total runout data, includes: calculating the net total runout data of the designated part based on the net runout curves, and generating a shaft axis state diagram and a shaft runout polar plot of the hydraulic turbine generator unit before the shaft axis is processed based on the net total runout data of the designated part; and using both the shaft axis state diagram and the shaft runout polar plot as the shaft axis data diagrams.

In an embodiment of this application, taking the calculation of the net total runout data at the lower guide bearing as an example, calculating the net total runout data of the designated part (i.e., the lower guide bearing) based on the net runout curves, and generating the shaft axis data diagram of the hydraulic turbine generator unit based on the net total runout data of the designated parts specifically includes: using the upper guide bearing as the center for the rotation of the hydraulic turbine generator unit, or assuming that the journal at the upper guide bearing is absolutely vertical; constructing a relative offset vector based on the net runout of the first direction and the net runout of the second direction at each measuring point in the net runout curves (including the first and second net runout curves) of the lower guide bearing, and the relative offset vector at each measuring point of the lower guide bearing is defined as a total swing degree, and the magnitude of this relative offset vector is taken as the net total runout at each measuring point of the lower guide bearing; obtaining the center point of the lower guide bearing according to the net total runout data at all measuring points of the lower guide bearing; applying the same calculation procedures to obtain center points of other designated parts, such as the center point of the intermediate shaft upper flange; and generating the shaft axis data diagram of the hydraulic turbine generator unit based on the center points of all designated parts. The total swing degree is a vector, representing a vector sum of the first runout data and the second runout data (i.e., the vector components).

The schematic diagram of the shaft axis state of the hydraulic turbine generator unit before the shaft axis is processed may be used to describe the positional relationships and the runout states of various characteristic parts (i.e., the designated parts) before the shaft is processed. In an embodiment, the center point of the upper guide bearing is used as the drawing reference point. Then, based on the calculated net total runouts of the lower guide bearing and the net total runouts of the water guide bearing, the horizontal offset positions of the center point of the lower guide bearing and center point of the water guide bearing relative to the center of the upper guide bearing are determined. Connecting the center point of the upper guide bearing, the center point of the lower guide bearing, and the center point of the water guide bearing with straight lines, and the obtained polygonal line represents the shaft axis state of the hydraulic turbine generator unit.

A shaft runout polar plot may be used to describe the specific runout values of various characteristic parts of the hydraulic turbine generator unit before processing the shaft axis and the corresponding orientations (i.e., shaft angle positions) where the runout occurs, thus clearly indicating the magnitude and location of the runout.

In an embodiment, the terminal uses a built-in algorithm to generate the schematic diagram of the shaft axis state of the hydraulic turbine generator unit before processing the shaft axis based on the net runout curves, and then, based on the net runout curves, automatically generates a shaft runout polar plot of the hydraulic turbine generator unit before the shaft is processed to clarify the specific runout values and orientation of each designated part, and uses the shaft axis state diagram and the shaft runout polar plot generated above as the shaft axis data diagrams.

In the technical solutions of this embodiment, the shaft axis state diagram and the shaft runout polar plot of the hydraulic turbine generator unit before the shaft is processed are generated and used as the shaft axis data diagrams, which facilitates obtaining more accurate and diverse shaft axis data diagrams, thereby facilitating improving the accuracy of the shaft axis processing for the hydraulic turbine generator unit.

The following application example illustrates the digitalized and intelligent shaft axis processing method for the hydraulic turbine generator unit provided in this application. This application example is described by taking the method executed via the terminal connected to the dial indicator installed on the designated part of the hydraulic turbine generator unit as an example, and the method mainly include step 1 to step 5.

In Step 1, two dial indicators are respectively installed in the first direction X (i.e., the positive X-direction) and the second direction Y (i.e., the positive Y-direction) on each characteristic part (i.e., each designated part) of the hydraulic turbine generator unit, and are connected to the terminal via data cables. The dial indicators are configured to collect the absolute runout data of each shaft position number of each characteristic part (i.e., each designated part) during a barring operation, and transmit the data to the terminal.

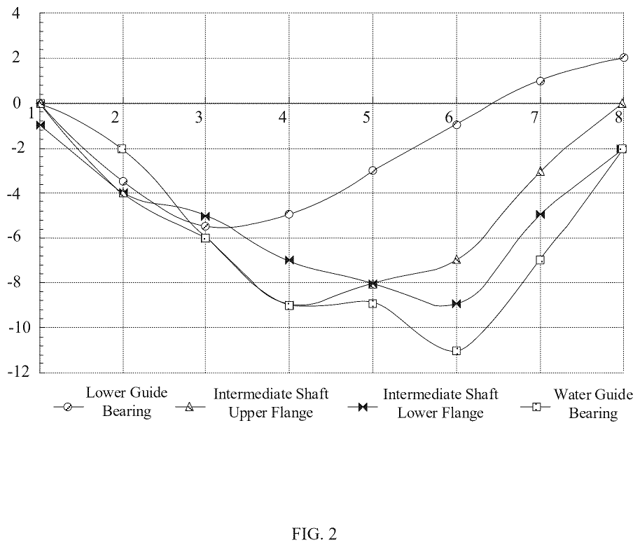

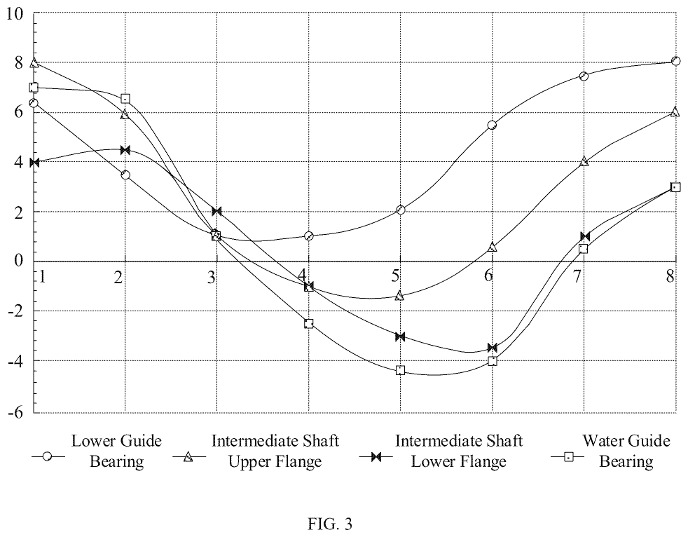

In Step 2, the barring operation of the hydraulic turbine generator unit is performed either manually or using the barring gear. Prior to the starting of barring, the initial position of the unit corresponding to the X-direction dial indicator is marked and designated as position “1”, and the initial position of the unit corresponding to the Y-direction dial indicator is marked and designated as position “1”. The barring operation is performed on the unit to make it rotate at a constant speed. One data signal is collected for each shaft angle number, and the dial indicator transmits the collected data signals to the terminal. After receiving the data signals, the terminal analyzes and processes the data signals, and generates the net runout curves corresponding to the first direction X and the second direction Y respectively. The two dial indicators are used for cross-verification to enhance fault tolerance. If any abnormality is detected, an alarm will be automatically issued. The first net runout curves (i.e., the net runout curves in the first direction X) are shown in FIG. 2. In FIG. 2, the horizontal coordinates include 1, 2, 3, 4, 5, 6, 7, and 8, which represent the shaft angle numbers, and the vertical coordinates include 4, 2, 0, −2, −4, −6, −8, −10, and −12, which represent the net runout values, with units of 0.01 mm. The first net runout curves shown in FIG. 2 include the first net runout curve of the lower guide bearing, the first net runout curve of the intermediate shaft upper flange, the first net runout curve of the intermediate shaft lower flange, and the first net runout curve of the water guide bearing. The second net runout curves (i.e., the net runout curves in the second direction Y) are shown in FIG. 3. In FIG. 3, the horizontal coordinates include 1, 2, 3, 4, 5, 6, 7, and 8, which represent the shaft position numbers, and the vertical coordinates include 10, 8, 6, 4, 2, 0, −2, −4, and −6, which represent the net runout values, with units of 0.01 mm. The second net runout curves shown in FIG. 3 include the second net runout curve of the lower guide bearing, the second net runout curve of the intermediate shaft upper flange, the second net runout curve of the intermediate shaft lower flange, and the second net runout curve of the water guide bearing.

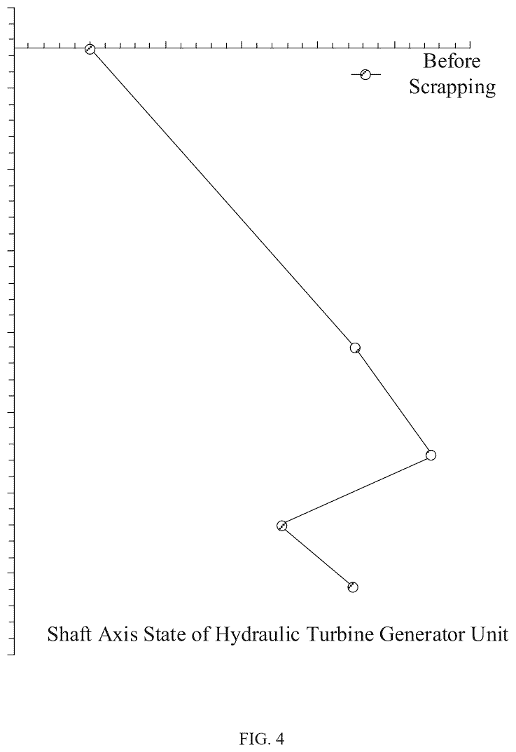

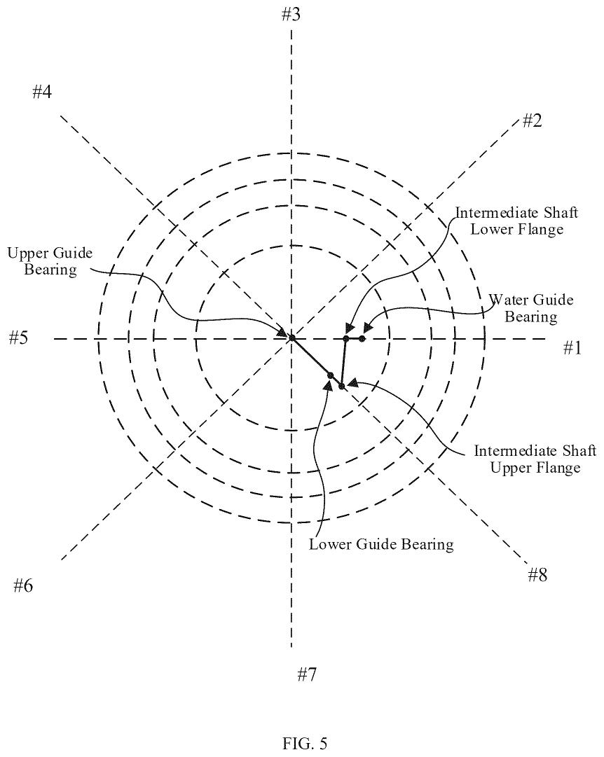

In Step 3, the terminal calculates the net total runout data for each characteristic part (i.e., the designated part) of the unit, and generates a schematic diagram of the shaft axis state of the hydraulic turbine generator unit and a shaft runout polar plot before processing the shaft axis. The schematic diagram of the shaft axis state of the hydraulic turbine generator unit before scraping the thrust collar clamping ring is shown in FIG. 4, which illustrates the positional relationships of various characteristic parts of the hydraulic turbine generator unit before scraping the thrust collar clamping ring. The shaft runout polar plot before scraping the thrust collar clamping ring is shown in FIG. 5, in which #1, #2, #3, #4, #5, #6, #7, and #8 are shaft angle numbers (representing various shaft angle positions). FIG. 5 is drawn by using the center point of the upper guide bearing as the reference point, and illustrates the specific runout values of the lower guide bearing, intermediate shaft upper flange, intermediate shaft lower flange, and water guide bearing, and the corresponding orientations (i.e., shaft angle positions) where the runouts occur.

In Step 4, after outputting the shaft axis state, the terminal automatically generates a shaft axis diagnostic report. At this time, the technical engineer may input data parameters such as the diameter of the thrust collar clamping ring of the unit and the distance between each characteristic part and the restraint guide bearing. The terminal automatically calculates and generates a shaft axis processing scheme for each characteristic part and a comprehensive shaft axis processing scheme (i.e., the thrust collar clamping ring scraping scheme, and the schematic diagram of scraping amount for each zone of the thrust collar clamping ring). Finally, the terminal outputs a schematic diagram of the shaft axis state after processing the shaft axis, and compares it with the schematic diagram of the shaft axis state before processing the shaft axis. The engineer may intuitively judge the effect of the shaft axis processing scheme. When having doubts about the calculation results, the technical engineer may also manually adjust the scraping amount for the thrust collar clamping ring, and the shaft axis state may be corrected accordingly.

An input device of the terminal receives the diameter of the thrust collar clamping ring of the hydraulic turbine generator unit and the distance between each designated part and the restraint guide bearing of the hydraulic turbine generator unit. The data input area (data parameter input area) may be used to configure the geometric parameters necessary for the unit barring. These geometric parameters may include the diameter of the clamping ring, the distance from the bottom of the clamping ring to the center of the lower guide bearing, the distance from the bottom of the clamping ring to the plane of the intermediate shaft upper flange, the distance from the bottom of the clamping ring to the plane of the intermediate shaft lower flange, the distance from the bottom of the clamping ring to the center of the water guide bearing, the diameter of the intermediate shaft upper flange of the generator, and the diameter of the intermediate shaft lower flange.

The processing scheme for a single characteristic part may include following key parameters and configurations: the high point value of the characteristic part may be set, the calculation reference point can be selected (which may be the lower guide bearing, the intermediate shaft upper flange, the intermediate shaft lower flange, or the water guide bearing), and based on these, the maximum scraping amount of the clamping ring can be calculated.

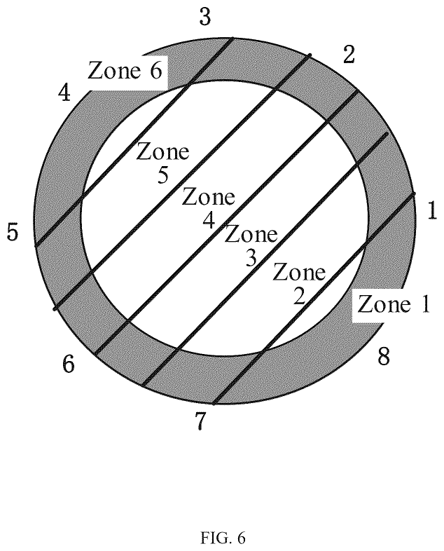

The schematic diagram of the scraping amount for each zone of the thrust collar clamping ring is shown in FIG. 6, which includes eight different measuring points (such as points 1, 2, 3, 4, 5, 6, 7 and 8). Using the centerline from the highest point to the lowest point of the clamping ring as a reference, the circumference of the clamping ring is divided into 6 zones (such as zone 1, zone 2, zone 3, zone 4, zone 5 and zone 6), and the scraping amount for each zone will be calculated and determined based on the data measured at these measuring points. For example, the highest point may be the point 8, and the lowest point may be the point 4. The scraping amount of zone 1 is 1.00, the scraping amount of zone 2 is 0.80, the scraping amount of zone 3 is 0.60, the scraping amount of zone 4 is 0.40, the scraping amount of zone 5 is 0.20, the scraping amount of zone 6 is 0, and the low point may be point 4. The units of these scraping amount may be 0.01 mm. Each zone of the thrust collar clamping ring is a circumferential zone, and the schematic diagram of the scraping amount for each zone of the thrust collar clamping ring indicates a thickness of material to be mechanically removed from the clamping ring in different circumferential zones.

The comprehensive shaft axis processing scheme for each characteristic part may include the following input information and output results. The input information (i.e., the shaft axis state before scraping the thrust collar clamping ring) includes the coordinates of each measuring point on the shaft axis of each of the designated parts (including the upper guide bearing, the lower guide bearing, the intermediate shaft upper flange, the intermediate shaft lower flange, and the water guide bearing), as well as the angle between the shaft axis of each designated part and the X-axis. The output results (i.e., the shaft axis processing scheme) may include the scraping amount of the clamping ring for each of the designated parts (including the upper guide bearing, the lower guide bearing, the intermediate shaft upper flange, the intermediate shaft lower flange, and the water guide bearing), the estimated runout value at each measuring point after scraping, and a standard range that the estimated runout values must comply with.

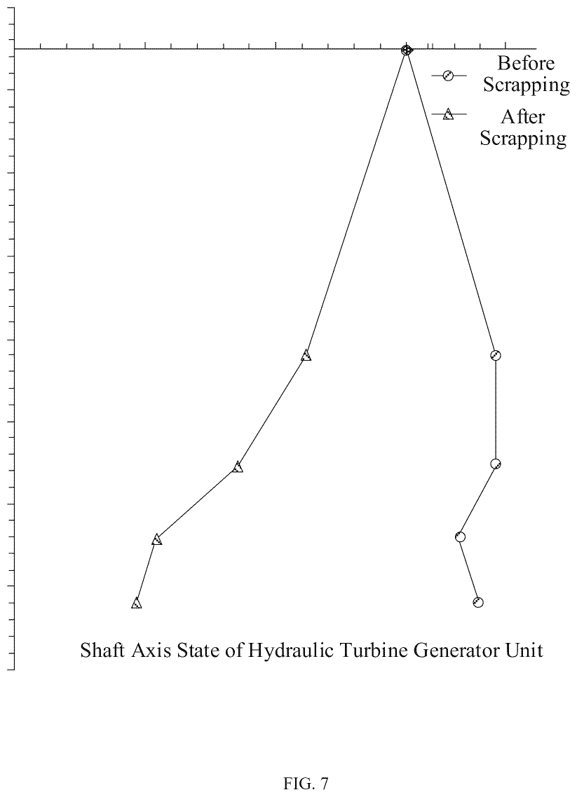

FIG. 7 shows a comparison schematic diagram of the shaft axis states of the hydraulic turbine generator unit before and after scraping the thrust collar clamping ring, and shows the shaft axis state of the unit before scraping the thrust collar clamping ring, and the shaft axis state of the unit after scraping the thrust collar clamping ring.

In Step 5, after confirming that the shaft axis processing scheme is correct, the thrust collar clamping ring may be scraped according to the schematic diagram of scraping amount for each zone of the thrust collar clamping ring. After processing, steps 1 to 4 are carried out repeatedly until the shaft axis of the unit is qualified.

The hydraulic turbine generator unit: as a power generation unit formed by the combination of each hydraulic turbine and its associated generator in a hydroelectric power station, it is the main power equipment for producing electricity in the hydroelectric power station. When the water introduced by the hydroelectric power station flows through the hydraulic turbine, the water energy is converted into mechanical energy to drive the machinery to rotate, and the generator then converts the mechanical energy into electrical energy for output.

Runout: a radial vibration of a certain part of the main shaft of the hydraulic turbine generator unit relative to an adjacent fixed part, and also known as a shaft relative vibration.

Barring: in a hydraulic turbine generator unit, multiple large shafts connect the rotor and the runner. Therefore, in order to determine the deviation between the actual center and the theoretical center of the unit, it is necessary to manually rotate the rotor through one full revolution, which is typically accomplished via the thrust bearing. Based on the measurement data, adjustments are made. If the deviation is not corrected, it will be amplified along the shaft axis and exceed permissible standards, thus adversely affecting the efficiency of the unit. The process usually requires multiple rotations to achieve the optimal centerline alignment.

Shaft Axis: the shaft axis of the unit refers to the geometric centerline of the rotating shaft of the hydraulic turbine generator unit.

Total runout: the total runout refers a difference between the dial indicator readings of the first direction or the second direction at two symmetrical measuring points of the same designated part. For example, the upper guide bearing includes eight bearing pads, and for the same designated part, i.e., the upper guide bearing, the total runout of the first direction of the upper guide bearing at the measuring point #1 refers the difference between the dial indicator readings of the first direction at two symmetrical measuring points, such as the measuring point #1 of the upper guide bearing and the measuring point #5 of the upper guide bearing. The total runout is actually the radial displacement of the main shaft. For the upper guide bearing, four total runout values of the first direction or the second direction may be obtained in total.

Net runout: the net runout refers to a difference between the dial indicator readings of the first direction or the second direction at the same measuring point of two designated parts, i.e., the upper and lower designated parts. For example, the upper guide bearing and the lower guide bearing each include eight bearing pads, the net runout of the first direction/the second direction at the measuring point #1 of the upper guide bearing refers to the difference between the dial indicator reading of the first direction/the second direction at the measuring point #1 of the upper guide bearing and the dial indicator reading of the first direction/the second direction at the measuring point #1 of the lower guide bearing.

Net total runout: the magnitude of the relative offset vector constructed by the difference between the dial indicator reading of the upper part at a measurement point and the dial indicator reading of the lower part at the same measurement point in the first direction, and the difference between the dial indicator reading of the upper part at the same measurement point and the dial indicator reading of the lower part at the same measurement point in the second direction. For example, the upper guide bearing and the lower guide bearing each include eight bearing pads. The difference between the runout data of the first direction (X) at measurement point #1 of the lower guide bearing and the runout data of the first direction (X) at measurement point #1 of the upper guide bearing is the net runout_X. The difference between the runout data of the second direction (Y) at measurement point #1 of the lower guide bearing and the runout data of the second direction (Y) at measurement point #1 of the upper guide bearing is the net runout_Y. The relative offset vector is constructed by the net runout_X and the net runout_Y, and the magnitude of this relative offset vector is referred to as the net total runout at measurement point #1 of the lower guide bearing.

The technical solution provided in this application example achieves the following technical effects: 1. The technical solution overcomes the high labor costs associated with traditional unit axis diagnostic methods. By utilizing equipment such as dial indicators and computers, the shaft axis diagnosis and processing for the unit become more digital and intelligent, thereby minimizing human resource costs. 2. The technical solution overcomes the limitations of conventional unit shaft axis diagnostic methods that rely heavily on the technical skills of technicians. This solution utilizes computers for the entire process of collecting, calculating, and processing the runout data collection of the unit, thereby eliminating the need for centralized training of a large number of technicians and significantly reducing time costs. 3. This technical solution overcomes the challenges of massive data computation and calculation errors in the shaft axis processing for the unit. The data collection and calculation process relies on computer-based intelligent computing, and dial indicators are arranged in both the positive X-direction and the positive Y-direction to collect data and the cross-verification is performed, thereby making data collection and calculation more accurate and reliable while significantly saving time costs. 4. This technical solution addresses the difficulty in calculating the shaft axis processing scheme and the shaft axis diagnosis for the unit. The technical solution uses computer-based intelligent computing to derive the optimal solution for the clamping ring, and allows manual verification by inputting target values, thus enabling quick acquisition of runout data at key characteristic points, and making the calculation process more convenient and reliable. 5. This technical solution resolves the lack of visualization of the shaft axis state in shaft axis diagnosis technology. This technical solution can not only automatically generate a schematic diagram of the shaft axis state based on data calculations, providing an intuitive representation of the shaft axis status, but also automatically produce a shaft axis diagnosis report and a schematic diagram of the shaft axis state after the shaft axis is processed, which allows for a clear comparison of the shaft states before and after processing the shaft axis, thereby aiding in a straightforward evaluation of the effectiveness of the shaft axis processing scheme. 6. This technical solution improves the efficiency and accuracy of the shaft axis processing for the hydraulic turbine generator unit.

It should be understood that although the steps in the flowcharts of the embodiments described above are shown sequentially according to the arrows, but these steps are not necessarily executed in the order indicated by the arrows. Unless explicitly stated herein, these steps are not necessarily performed strictly according to an order, and these steps may be performed in any other order. Moreover, at least part of the steps in the flowchart may include multiple steps or multiple stages, and these steps or stages are not necessarily executed and completed at the same time, but may be executed at different times. These steps or stages are not necessarily executed in sequence, but may be performed in turn or alternately with other steps or with at least a portion of steps or stages in the other steps.

Based on the same inventive concept, this application also provides a digitalized and intelligent shaft axis processing device for a hydraulic turbine generator unit for implementing the aforementioned digitalized and intelligent shaft axis processing method for the hydraulic turbine generator unit. The solution provided by this device is similar to the implementation described in the above method. Therefore, the specific limitations of one or more embodiments of the digitalized and intelligent shaft axis processing device for the hydraulic turbine generator unit provided below may be found in the above-described limitations of the digitalized and intelligent shaft axis processing method for a hydraulic turbine generator unit, and will not be repeated herein.

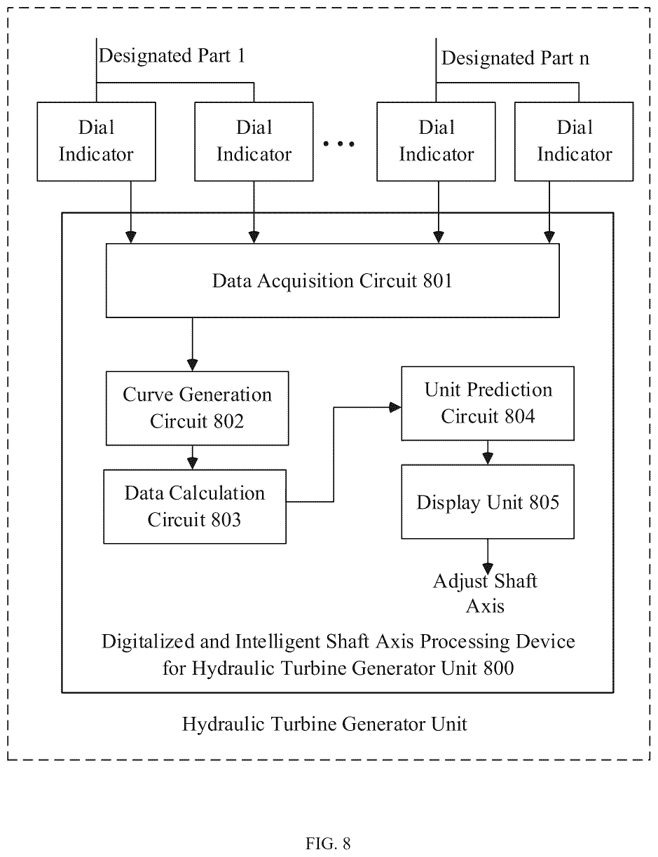

In an embodiment, as shown in FIG. 8, a digitalized and intelligent shaft axis processing device for a hydraulic turbine generator unit is provided, and applied in the hydraulic turbine generator unit. The hydraulic turbine generator unit includes a dial indicator disposed on a designated part, and the dial indicator is connected to the digitalized and intelligent shaft axis processing device for the hydraulic turbine generator unit 800 via data cables. The dial indicator is configured to collect the runout data of the designated part at multiple shaft angle positions. Specifically, the dial indicator is configured to collect the first runout data of the designated part in the first preset direction X at multiple shaft angle positions and the second runout data of the designated part in the second preset direction Y at multiple shaft angle positions during the rotation of the hydraulic turbine generator unit. The digitalized and intelligent shaft axis processing device for the hydraulic turbine generator unit 800 may include: a data acquisition circuit 801, a curve generation circuit 802, a data calculation circuit 803, a unit prediction circuit 804, and a display unit 805.

An input terminal of the data acquisition circuit 801 is connected to an output terminal of the dial indicator, and the data acquisition circuit 801 is configured to receive the runout data of a designated part of the hydraulic turbine generator unit collected by the dial indicator at multiple shaft angle positions.

An input terminal of the curve generation circuit 802 is connected to an output terminal of the data acquisition circuit 801, and the curve generation circuit 802 is configure to generate net runout curves of the designated part based on the runout data.

An input terminal of the data calculation circuit 803 is connected to an output of the curve generation circuit 802, and the data calculation circuit 803 is configured to calculate net total runout data of the designated part based on the net runout curves, and generate a shaft axis data diagram of the hydraulic turbine generator unit based on the net total runout data.

An input terminal of the unit prediction circuit 804 is connected to an output of the data calculation circuit 803, and the unit prediction circuit 804 is configured to perform a shaft axis processing prediction for the hydraulic turbine generator unit based on the net total runout data and the shaft axis data diagram to obtain the shaft axis processing scheme for the hydraulic turbine generator unit.

An input terminal of the display unit 805 is connected to an output terminal of the unit prediction circuit 804, and the display unit 805 is configured to output the shaft axis processing scheme to guide the adjustment of the hydraulic turbine generator unit on site to correct the shaft axis of the hydraulic turbine generator unit to a qualified operating state.

In an embodiment, dial indicators are disposed in the first preset direction X and the second preset direction Y of the designated part respectively. The data acquisition circuit 801 is also configured to receive the first runout data of the first preset direction X and the second runout data of the second preset direction Y sent by the dial indicator. Both the first and second runout data are collected by the dial indicator when the hydraulic turbine generator unit is in a barring state, i.e., during the rotation of the hydraulic turbine generator unit. Both the first and second runout data are used as runout data.

In an embodiment, the curve generation circuit 802 is further configured to: generate the first net runout curve of the first preset direction based on the first runout data; generate the second net runout curve of the second preset direction based on the second runout data; perform a matching detection on the first net runout curve and the second net runout curve to determine whether the first net runout curve and the second net runout curve match with each other; corresponding to a determination that the first net runout curve and the second net runout curve match, use both the first net runout curve and the second net runout curve as the net runout curves of the designated part; corresponding to a determination that the first net runout curve and the second net runout curve do not match with each other, check whether the collected data is incorrect or instruct the dial indicators to repeat the measurement to generate new net runout curves for matching detection.

In an embodiment, the unit prediction circuit 804 is further configured to obtain a diameter of the thrust collar clamping ring of the hydraulic turbine generator unit and a distance between each designated part and a restraint guide bearing of the hydraulic turbine generator unit as equipment parameters of the hydraulic turbine generator unit; and perform the shaft axis processing prediction for the hydraulic turbine generator unit based on the equipment parameters, the net total runout data, and the shaft axis data diagram to obtain the shaft axis processing scheme for the hydraulic turbine generator unit.

In an embodiment, the curve generation circuit 802 is further configured to generate an alarm signal corresponding to the determination that the first net runout curve and the second net runout curve do not match with each other.

In an embodiment, the unit prediction circuit 804 is further configured to perform the shaft axis processing prediction for the hydraulic turbine generator unit based on the equipment parameters, the net total runout data, and the shaft axis data diagram to obtain a shaft axis processing scheme for the designated part and a comprehensive shaft axis processing scheme for the hydraulic turbine generator unit; generate a scraping scheme for thrust collar clamping ring and a diagram of scraping amount for each zone of the thrust collar clamping ring of the hydraulic turbine generator unit based on the shaft axis processing scheme for the designated part and the comprehensive shaft axis processing scheme for the hydraulic turbine generator unit; and use the scraping scheme for the thrust collar clamping ring and the diagram of scraping amount for each zone of the thrust collar clamping ring as the shaft axis processing scheme.

In an embodiment, the device 800 further includes an information generation circuit, configured to generate a comparison schematic diagram of the shaft axis states of the hydraulic turbine generator unit before and after the thrust collar clamping ring is scraped based on the scraping scheme for the thrust collar clamping ring and the schematic diagram of the scraping amount for each zone of the thrust collar clamping ring; and use the shaft axis processing scheme and the comparison schematic diagram of the shaft axis states as auxiliary information for scraping the thrust collar clamping ring of the hydraulic turbine generator unit.

In an embodiment, the data calculation circuit 803 is further configured to calculate the net total runout data of the designated part based on the net runout curves, and generate a schematic shaft axis state diagram and a shaft runout polar plot of the hydraulic turbine generator unit before the shaft axis is processed based on the net total runout data of the designated part; and use both the schematic shaft axis state diagram and the shaft runout polar plot before the shaft axis is processed as the shaft axis data diagrams.

The circuits in the aforementioned digitalized and intelligent shaft axis processing device for hydraulic turbine generator unit may be implemented entirely or partially through hardware. These circuits may be embedded in or independent of the processor in a computer device, or stored in the memory of a computer device as software, so that the processor may call and execute the operations corresponding to each circuit above.

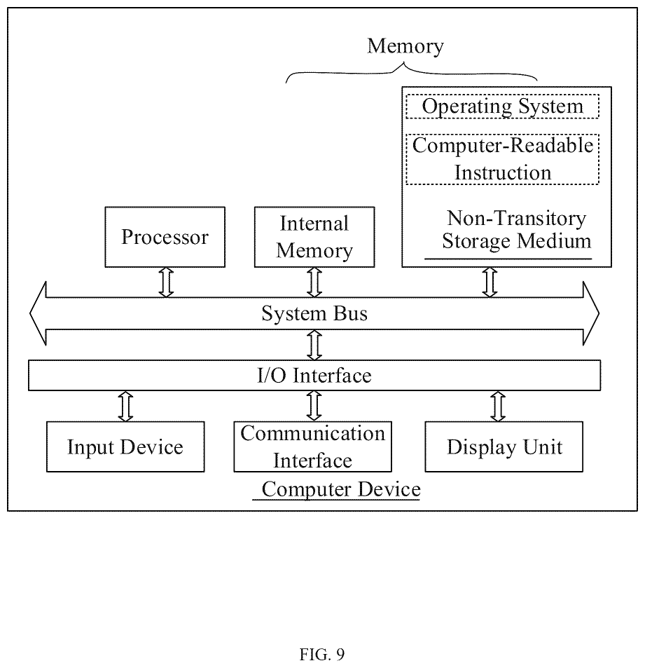

In an embodiment, a computer device is provided, which may be a terminal, and its internal structure may be as shown in FIG. 9. The computer device includes a processor, memory, input/output interfaces, a communication interface, a display unit, and an input device. The processor, memory, and input/output interfaces are connected via a system bus, and the communication interface, display unit, and input device are also connected to the system bus via the input/output interfaces. The processor of the computer device provides computing and control capabilities. The memory of the computer device includes a non-transitory storage medium and internal memory. The non-transitory storage medium stores an operating system and computer-readable instructions. The internal memory provides an environment for the operation of the operating system and computer-readable instructions in the non-transitory storage medium. The input/output interfaces of the computer device are used for exchanging information between the processor and external devices. The communication interface of the computer device is used for wired or wireless communication with an external terminal; wireless communication may be achieved through Wi-Fi, mobile cellular networks, NFC (Near Field Communication), or other technologies. When executed by the processor, the computer-readable instructions implement the digitalized and intelligent shaft axis processing method for the hydraulic turbine generator unit. The display unit of the computer device is used to form a visually visible image and may be a display screen, a projection device, or a virtual reality imaging device. The display screen may be an LCD screen or an e-ink screen. The input device of the computer device may be a touch layer covering the display screen, or buttons, trackballs, or touchpads disposed on the casing of the computer device, or external keyboards, touchpads, or mice, etc.

Those skilled in the art will understand that the structure shown in FIG. 9 is merely a block diagram of a portion of the structure related to the present application and does not constitute a limitation on the computer device to which the present application is applied. Specific computer devices may include more or fewer components than those shown in the figure, or may combine certain components, or may have different component arrangements.

In an embodiment, a computer device is also provided, which is a terminal including a memory and one or more processors. The memory stores computer-readable instructions that, when executed by the processor, implement the steps of the digitalized and intelligent shaft axis processing method for the hydraulic turbine generator unit provided in any one of the embodiments of this application.

In an embodiment, a non-transitory computer-readable storage medium is provided, on which computer-readable instructions are stored. The computer is a terminal, and the computer-readable instructions, when executed by one or more processors of the terminal, cause the one or more processors to implement the steps of the digitalized and intelligent shaft axis processing method for the hydraulic turbine generator unit provided in any one of the embodiments of this application.

In an embodiment, a computer program product is provided, including computer-readable instructions. The computer is a terminal, and the computer-readable instructions, when executed by the processor of the terminal, implement the steps of the digitalized and intelligent shaft axis processing method for the hydraulic turbine generator unit provided in any one of the embodiments of this application.

It should be noted that the user information (including but not limited to user device information, user personal information, etc.) and data (including but not limited to data used for analysis, data stored, data displayed, etc.) involved in this application are all information and data authorized by the user or fully authorized by all parties, and the collection, use and processing of the relevant data must comply with relevant regulations.

Those ordinary skilled in the art will understand that all or part of the processes in the methods of the above embodiments may be implemented by instructing related hardware through computer-readable instructions. These computer-readable instructions may be stored in a non-transitory computer-readable storage medium. When executed, these computer-readable instructions may include the processes of the embodiments of the above methods. Any references to memory, databases, or other media used in the embodiments provided in this application may include at least one of non-transitory and volatile memory. Non-transitory memory may include read-only memory (ROM), magnetic tape, floppy disk, flash memory, optical memory, high-density embedded non-volatile memory, resistive random access memory (ReRAM), magnetic random access memory (MRAM) , ferroelectric random access memory (FRAM), phase change memory (PCM), graphene memory, etc. Volatile memory may include random access memory (RAM) or external cache memory, etc. By way of illustration and not limitation, RAM may take many forms, such as Static Random Access Memory (SRAM) or Dynamic Random Access Memory (DRAM). The databases involved in the embodiments provided in this application may include at least one of relational database and non-relational database. Non-relational databases may include, but are not limited to, blockchain-based distributed databases. The processors involved in the embodiments provided in this application may be general-purpose processors, central processing units, graphics processing units, digital signal processors, programmable logic devices, quantum computing-based data processing logic devices, etc., and are not limited thereto.

The technical features of the embodiments above may be combined arbitrarily. To make the description concise, not all possible combinations of the technical features in the above embodiments are described. However, as long as there are no contradictions in the combinations of these technical features, all of the combinations should be considered to be within the scope of the specification.

The embodiments above only represent several implementations of the present application, and the description thereof is relatively specific and detailed, but it should not be construed as limiting the scope of the patent. It should be noted that for those skilled in the art, various modifications and improvements may be made without departing from the concept of the present application, and all these modifications and improvements belong to the protection scope of the present application. Therefore, the scope of protection of the patent application should be subject to the appended claims.

What is claimed is:

1. A digitalized and intelligent shaft axis processing method for a hydraulic turbine generator unit, wherein the hydraulic turbine generator unit comprises a dial indicator disposed on a designated part and a terminal, the dial indicator is connected to the terminal via a data cable, and the shaft axis processing method for the hydraulic turbine generator unit comprises:
the dial indicator collecting first runout data of the designated part in a first preset direction (X) at multiple shaft angle positions and second runout data of the designated part in a second preset direction (Y) at the multiple shaft angle positions during a rotation of the hydraulic turbine generator unit;
the terminal receiving the first runout data of the designated part of the hydraulic turbine generator unit in the first preset direction (X) at the multiple shaft angle positions and the second runout data of the designated part in the second preset direction (Y) at the multiple shaft angle positions sent by the dial indicator;
the terminal generating a first net runout curve of the first preset direction based on the first runout data, and generating a second net runout curve of the second preset direction based on the second runout data;
the terminal performing a matching detection on the first net runout curve and the second net runout curve to determine whether the first net runout curve and the second net runout curve match with each other;
corresponding to a determination that the first net runout curve and the second net runout curve match with each other, the terminal using the first net runout curve and the second net runout curve as the net runout curves of the designated part, and corresponding to a determination that the first net runout curve and the second net runout curve do not match with each other, the terminal checking whether collected data is incorrect or instructing the dial indicator to repeat measurement to generate new net runout curves for the matching detection;
the terminal calculating net total runout data of the designated part based on the net runout curves of the designated part, and generating a shaft axis data diagram of the hydraulic turbine generator unit based on the net total runout data;
the terminal performing a shaft axis processing prediction for the hydraulic turbine generator unit based on the net total runout data and the shaft axis data diagram to obtain a shaft axis processing scheme for the hydraulic turbine generator unit; and
a display unit of the terminal outputting the shaft axis processing scheme to guide an adjustment of the hydraulic turbine generator unit on site to correct the shaft axis of the hydraulic turbine generator unit to a qualified operating state.

2. The method according to claim 1, wherein dial indicators are disposed in the first preset direction (X) and the second preset direction (Y) of the designated part, respectively; and the designated part comprises at least one of a lower guide bearing, an intermediate shaft upper flange, an intermediate shaft lower flange, or a water guide bearing.

3. The method according to claim 1, further comprising: corresponding to the determination that the first net runout curve and the second net runout curve do not match with each other, the terminal generating an alarm signal.

4. The method according to claim 1, wherein the terminal performing the shaft axis processing prediction for the hydraulic turbine generator unit based on the net total runout data and the shaft axis data diagram to obtain the shaft axis processing scheme for the hydraulic turbine generator unit, comprises:
the terminal obtaining a diameter of a thrust collar clamping ring of the hydraulic turbine generator unit and a distance between each designated part and a restraint guide bearing of the hydraulic turbine generator unit, and using the diameter and the distances as equipment parameters of the hydraulic turbine generator unit; and
the terminal performing the shaft axis processing prediction for the hydraulic turbine generator unit based on the equipment parameters, the net total runout data, and the shaft axis data diagram to obtain the shaft axis processing scheme for the hydraulic turbine generator unit.

5. The method according to claim 4, wherein the terminal obtaining the diameter of the thrust collar clamping ring of the hydraulic turbine generator unit and the distance between each designated part and the restraint guide bearing of the hydraulic turbine generator unit, comprises:
an input device of the terminal receiving the diameter of the thrust collar clamping ring of the hydraulic turbine generator unit and the distance between each designated part and the restraint guide bearing of the hydraulic turbine generator unit.

6. The method according to claim 4, wherein the terminal performing the shaft axis processing prediction for the hydraulic turbine generator unit based on the equipment parameters, the net total runout data, and the shaft axis data diagram to obtain the shaft axis processing scheme for the hydraulic turbine generator unit, comprises:
performing the shaft axis processing prediction for the hydraulic turbine generator unit based on the equipment parameters, the net total runout data, and the shaft axis data diagram to obtain a shaft axis processing scheme for the designated part and a comprehensive shaft axis processing scheme for the hydraulic turbine generator unit;
generating a scraping scheme for thrust collar clamping ring of the hydraulic turbine generator unit and a diagram of scraping amount for each zone of the thrust collar clamping ring of the hydraulic turbine generator unit based on the shaft axis processing scheme for the designated part and the comprehensive shaft axis processing scheme for the hydraulic turbine generator unit; and
using the scraping scheme for the thrust collar clamping ring and the diagram of the scraping amount for each zone of the thrust collar clamping ring as the shaft axis processing scheme for the hydraulic turbine generator unit.

7. The method according to claim 6, wherein after the terminal using the scraping scheme for the thrust collar clamping ring and the diagram of the scraping amount for each zone of the thrust collar clamping ring as the shaft axis processing scheme for the hydraulic turbine generator unit, the method further comprises:
the terminal generating a comparison diagram of shaft axis states of the hydraulic turbine generator unit before and after the thrust collar clamping ring is scraped based on the scraping scheme for the thrust collar clamping ring and the diagram of the scraping amount for each zone of the thrust collar clamping ring; and
the terminal using the shaft axis processing scheme and the comparison diagram of the shaft axis states as auxiliary information for scraping the thrust collar clamping ring of the hydraulic turbine generator unit.

8. The method according to claim 7, wherein each zone of the thrust collar clamping ring is a circumferential zone, and the diagram of the scraping amount for each zone of the thrust collar clamping ring indicates a thickness of material to be mechanically removed from the clamping ring in different circumferential zones.

9. The method according to claim 1, wherein the terminal calculating the net total runout data of the designated part based on the net runout curves of the designated part, and generating the shaft axis data diagram of the hydraulic turbine generator unit based on the net total runout data, comprises:
calculating the net total runout data of the designated part based on the net runout curves, and generating a shaft axis state diagram and a shaft runout polar plot of the hydraulic turbine generator unit before the shaft axis is processed based on the net total runout data of the designated part; and
using both the shaft axis state diagram and the shaft runout polar plot as the shaft axis data diagrams.

10. A digitalized and intelligent shaft axis processing device for a hydraulic turbine generator unit, wherein the hydraulic turbine generator unit comprises a dial indicator disposed in a designated part, the dial indicator is connected to the digitalized and intelligent shaft axis processing device for the hydraulic turbine generator unit via a data cable;
the dial indicator is configured to collect first runout data of the designated part in a first preset direction (X) at multiple shaft angle positions and second runout data of the designated part in a second preset direction (Y) at the multiple shaft angle positions during a rotation of the hydraulic turbine generator unit; and
the digitalized and intelligent shaft axis processing device for the hydraulic turbine generator unit comprises:
a data acquisition circuit, an input terminal of the data acquisition circuit being connected to an output terminal of the dial indicator, and the data acquisition circuit being configured to receive the first runout data of the designated part of the hydraulic turbine generator unit in the first preset direction (X) at the multiple shaft angle positions and the second runout data of the designated part in the second preset direction (Y) at the multiple shaft angle positions sent by the dial indicator;
a curve generation circuit, an input terminal of the curve generation circuit being connected to an output terminal of the data acquisition circuit, and the curve generation circuit being configured to generate a first net runout curve of the first preset direction based on the first runout data, and generate a second net runout curve of the second preset direction based on the second runout data; perform a matching detection on the first net runout curve and the second net runout curve to determine whether the first net runout curve and the second net runout curve match with each other; corresponding to a determination that the first net runout curve and the second net runout curve match with each other, use the first net runout curve and the second net runout curve as the net runout curves of the designated part, and corresponding to a determination that the first net runout curve and the second net runout curve do not match with each other, check whether collected data is incorrect or instruct the dial indicator to repeat measurement to generate new net runout curves for the matching detection;
a data calculation circuit, an input terminal of the data calculation circuit being connected to an output terminal of the curve generation circuit, and the data calculation circuit being configured to calculate net total runout data of the designated part based on the net runout curves of the designated part, and generate a shaft axis data diagram of the hydraulic turbine generator unit based on the net total runout data;
a unit prediction circuit, an input terminal of the unit prediction circuit being connected to an output terminal of the data calculation circuit, and the unit prediction circuit being configured to perform a shaft axis processing prediction for the hydraulic turbine generator unit based on the net total runout data and the shaft axis data diagram to obtain a shaft axis processing scheme for the hydraulic turbine generator unit; and
a display unit, an input terminal of the display unit being connected to an output terminal of the unit prediction circuit, and the display unit being configured to output the shaft axis processing scheme to guide an adjustment of the hydraulic turbine generator unit on site to correct the shaft axis of the hydraulic turbine generator unit to a qualified operating state.

11. The device according to claim 10, wherein dial indicators are disposed in the first preset direction (X) and the second preset direction (Y) of the designated part, respectively; the designated part comprises at least one of a lower guide bearing, an intermediate shaft upper flange, an intermediate shaft lower flange, or a water guide bearing.

12. The device according to claim 10, wherein the curve generation circuit is further configured to generate an alarm signal corresponding to the determination that the first net runout curve and the second net runout curve do not match with each other.

13. The device according to claim 10, wherein the unit prediction circuit is further configured to obtain a diameter of a thrust collar clamping ring of the hydraulic turbine generator unit and a distance between each designated part and a restraint guide bearing of the hydraulic turbine generator unit, and use the diameter and the distances as equipment parameters of the hydraulic turbine generator unit; and perform the shaft axis processing prediction for the hydraulic turbine generator unit based on the equipment parameters, the net total runout data, and the shaft axis data diagram to obtain the shaft axis processing scheme for the hydraulic turbine generator unit.

14. The device according to claim 13, further comprising an input device configured to receive the diameter of the thrust collar clamping ring of the hydraulic turbine generator unit and the distance between each designated part and the restraint guide bearing of the hydraulic turbine generator unit.

15. The device according to claim 13, wherein the unit prediction circuit is further configured to perform the shaft axis processing prediction for the hydraulic turbine generator unit based on the equipment parameters, the net total runout data, and the shaft axis data diagram to obtain a shaft axis processing scheme for the designated part and a comprehensive shaft axis processing scheme for the hydraulic turbine generator unit; generate a scraping scheme for thrust collar clamping ring and a diagram of scraping amount for each zone of the thrust collar clamping ring of the hydraulic turbine generator unit based on the shaft axis processing scheme for the designated part and the comprehensive shaft axis processing scheme for the hydraulic turbine generator unit; and use the scraping scheme for the thrust collar clamping ring and the diagram of the scraping amount for each zone of the thrust collar clamping ring as the shaft axis processing scheme for the hydraulic turbine generator unit.

16. The device according to claim 15, further comprising an information generation circuit configured to generate a comparison diagram of shaft axis states of the hydraulic turbine generator unit before and after the thrust collar clamping ring is scraped based on the scraping scheme for the thrust collar clamping ring and the diagram of the scraping amount for each zone of the thrust collar clamping ring; and use the shaft axis processing scheme and the comparison diagram of the shaft axis states as auxiliary information for scraping the thrust collar clamping ring of the hydraulic turbine generator unit.

17. The device according to claim 16, wherein each zone of the thrust collar clamping ring is a circumferential zone, and the diagram of the scraping amount for each zone of the thrust collar clamping ring indicates a thickness of material to be mechanically removed from the clamping ring in different circumferential zones.

18. The device according to claim 10, wherein the data calculation circuit is further configured to:
calculate the net total runout data of the designated part based on the net runout curves, and generate a shaft axis state diagram and a shaft runout polar plot of the hydraulic turbine generator unit before the shaft axis is processed based on the net total runout data of the designated part; and
use both the shaft axis state diagram and the shaft runout polar plot as the shaft axis data diagrams.

19. A computer device, being a terminal comprising a memory and one or more processors, the memory storing computer-readable instructions, wherein the computer-readable instructions, when executed by the one or more processors, perform the method of claim 1.

20. A non-transitory computer-readable storage medium, having computer-readable instructions stored thereon, the computer being a terminal, wherein the computer-readable instructions, when executed by one or more processors of the terminal, cause the one or more processors to perform the method of claim 1.
